(19) United States
(12) Patent Application Publication
(10) Pub. No.: US 2005/0197837 A1
(43) Pub. Date: Sep. 8, 2005

(54) Enhanced multilingual speech recognition system

(76) Inventors: Janne Suontausta, Tampere (FI); Juha Iso-Sipila, Tampere (FI); Marcel Vasilache, Tampere (FI)

Correspondence Address: CRAWFORD MAUNU PLLC, 1270 NORTHLAND DRIVE, SUITE 390, ST. PAUL, MN, 55120, US

(21) Appl. No.: 10/795,640

(22) Filed: Mar. 8, 2004

(51) Int. Cl. G10L 15/00

(52) U.S. Cl. 704/260

(57) ABSTRACT

A speech recognition system comprising: a language identification unit for identifying the language of a text item entry; at least one separate pronunciation modelling unit including a phoneme set and pronunciation model for at least one language; means for activating the pronunciation modelling unit including the phoneme set and pronunciation model for the language corresponding to the language identified in the language identification unit for obtaining a phoneme transcription for the entry; and a multilingual acoustic modelling unit for creating a recognition model for the entry.

### FIELD OF THE INVENTION

The invention relates to speech recognition, and particularly to speaker-independent multilingual speech recognition systems.

### BACKGROUND OF THE INVENTION

Different speech recognition applications have been developed during recent years for instance for car user interfaces and mobile terminals, such as mobile phones, PDA devices and portable computers. Known methods for mobile terminals include methods for calling a particular person by saying aloud his/her name into the microphone of the mobile terminal and by setting up a call to the number according to the name said by the user. However, present speaker-dependent methods usually require that the speech recognition system is trained to recognize the pronunciation for each word.

Speaker-independent speech recognition improves the usability of a speech-controlled user interface, because the training stage can be omitted. In speaker-independent word recognition, the pronunciation of words can be stored beforehand, and the word spoken by the user can be identified with the pre-defined pronunciation, such as a phoneme sequence. Although in many languages pronunciation of many words can be represented by rules, or even by models, the pronunciation of some words can still not be correctly generated with these rules or models. Moreover, in some languages, the pronunciation cannot be represented by general pronunciation rules, but each word has a specific pronunciation. In these languages, speech recognition relies on the use of so-called pronunciation dictionaries in which a written form of each word of the language and the phonetic representation of its pronunciation are stored in a list-like structure.

However, in mass products offered to global markets, like in mobile terminals, the importance of a multilingual speech recognition system is emphasized. In mobile phones the available memory size and processing power are often limited due to reasons of cost and hardware size. This also imposes limitations on speech recognition applications. Language- and speaker-independent speech recognition systems have been developed with these limitations in mind.

A particular language- and speaker-independent speech recognition system can be called a multilingual automatic speech recognition system (ML-ASR) and it is further illustrated in FIG. 1. The ML-ASR engine consists of three key units: automatic language identification (LID, 100), on-line pronunciation modeling (Text-to-Phoneme mapping, TTP, 104), and multilingual acoustic modeling modules (AMM, 108). The vocabulary items are given in textual form and they are read in for example from a text file or a name database called a vocabulary file. The on-line pronunciation module, i.e. TTP module, is an integral part of the ML-ASR engine and it includes phoneme definitions and pronunciation models for all target languages implemented as a large file or a database (106). The LID module finds the language identity of a vocabulary item based on the language identification model (102). After the language identity is known, an appropriate on-line TTP modeling scheme is applied from the TTP module to obtain the phoneme transcription for the vocabulary item. Finally, the recognition model for each vocabulary item is constructed as a concatenation of multilingual acoustic models specified by the phoneme transcription. Using these basic modules the recognizer (REG, 110) can, in principle, automatically cope with multilingual vocabulary items without any assistance from the user. The ML-ASR system according to FIG. 1 is further depicted in a conference publication: O. Viikki, I. Kiss, J. Tian, “Speaker- and Language-Independent Speech Recognition in Mobile Communication Systems”, In Proceedings of International Conference on Acoustics, Speech, and Signal Processing, Salt Lake City, Utah, USA, 2001.

The TTP modeling has the key role in providing the phoneme transcriptions for the multi-lingual vocabulary items. The accuracy of the speech recognition engine depends heavily on the correctness of the phonetic transcriptions for the vocabulary and on the phoneme definitions of the target languages. The accuracy is, however, limited in the practical implementation of the ML-ASR engine. The total number of phonemes of all the supported languages is limited due to memory restrictions of the acoustic modeling module AMM. In addition, due to memory and processing power limitations the phoneme definitions are hard coded in the source files of the engine. This makes it very difficult and cumbersome to change or update the phoneme definitions.

### BRIEF DESCRIPTION OF THE INVENTION

There is now provided a more flexibly updateable speech recognition system, wherein the accuracy of the speech recognition can be enhanced. Different aspects of the invention include a speech recognition system, methods, an electronic device, computer program products and hardware modules, which are characterized by what has been disclosed in the independent claims. Some embodiments of the invention are disclosed in the dependent claims.

The idea underlying the invention is that there is provided a speech recognition system, which comprises a language identification unit for identifying the language of a text item entry; at least one separate pronunciation modelling unit including a phoneme set and pronunciation model for at least one language; means for activating the pronunciation modelling unit including the phoneme set and pronunciation model for the language corresponding to the language identified in the language identification unit for obtaining a phoneme transcription for the entry; and a multilingual acoustic modelling unit for creating a recognition model for the entry.

An advantage of the system is that only one TTP model package is activated at a time. Since each TTP model package provides the phoneme set and the data of the pronunciation model typically only for one language, the number of language-dependent phonemes can be increased significantly in each TTP model package, thus resulting in increased accuracy of speech recognition.

According to an embodiment of the invention, the at least one separate pronunciation modelling unit includes one or more of the following pronunciation models: look-up tables, pronunciation rules, decision trees, or neural networks. The use of various pronunciation models enhances the accuracy of the speech recognition.

According to an embodiment of the invention, the at least one separate pronunciation modelling unit is stored as a binary file. Thus, the TTP model package is executable, as such, in the ML-ASR engine and also portable across various platforms running the ML-ASR engine.

According to an embodiment of the invention, the at least one separate pronunciation modelling unit is run-time configurable. This benefit is enabled by the fact that TTP model packages can be implemented as data modules, which are separate from the rest of ML-ASR engine code and the operation of the other parts of the ML-ASR engine is independent of the TTP models.

According to an embodiment of the invention, said means for activating the pronunciation modelling unit are arranged to switch run-time between a plurality of separate pronunciation modelling units according to the language identification of the speech item entry.

As a second aspect of the invention, there is provided a method for modifying speech recognition data in a multilingual speech recognition system, which method comprises: entering at least one text item in the device via an input means; identifying the language of the text item entry; activating, from a group of a plurality of separate pronunciation modelling units, the pronunciation modelling unit including a phoneme set and pronunciation model for the language corresponding to the language identified in the language identification unit; obtaining a phoneme transcription best corresponding to said text item entry; and storing a character string of the text item entry with the corresponding obtained phoneme transcription in said pronunciation modelling unit.

### BRIEF DESCRIPTION OF THE DRAWINGS

In the following the invention will be described in greater detail by means of preferred embodiments with reference to the attached drawings, in which

FIG. 1 shows a prior known multilingual automatic speech recognition system;

FIG. 2 shows a data processing device, wherein the speech recognition system according to the invention can be implemented;

FIG. 3 shows a multilingual automatic speech recognition system according to the invention;

FIG. 4 shows the data structure of the TTP model package as a table;

FIG. 5 shows a flow chart of a method according to an aspect of the invention; and

FIG. 6 shows a flow chart of a method according to an embodiment of the invention.

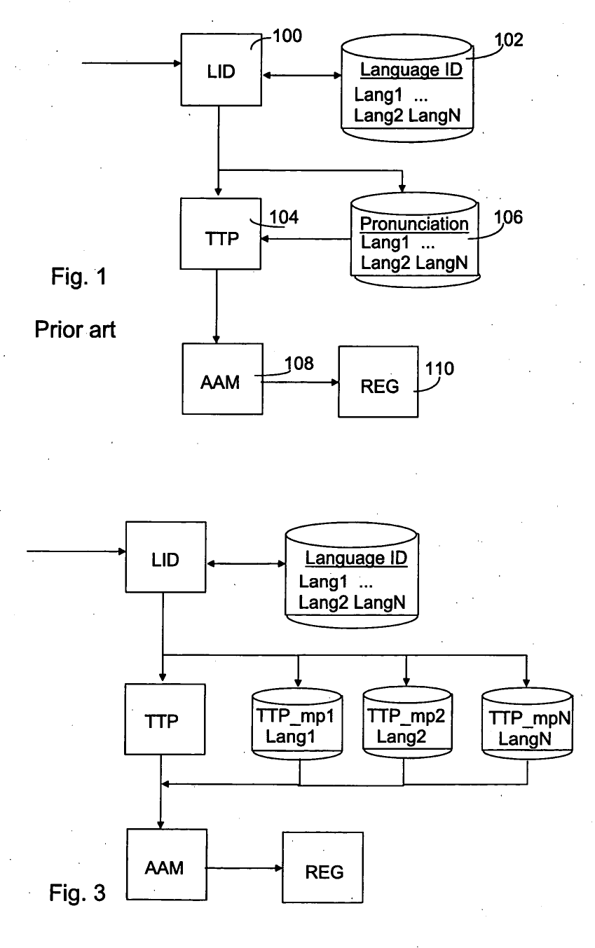

### DETAILED DESCRIPTION OF THE INVENTION

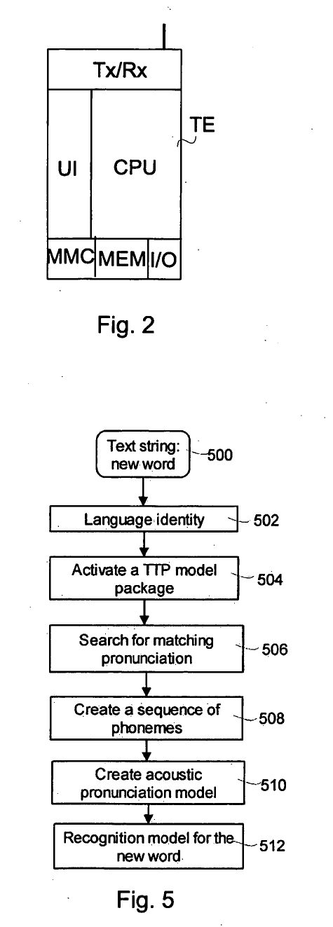

FIG. 2 illustrates a simplified structure of a data processing device (TE) according to an embodiment of the invention. The data processing device (TE) can be, for example, a mobile terminal, a PDA device or a personal computer (PC). The data processing unit (TE) comprises I/O means (I/O), a central processing unit (CPU) and memory (MEM). The memory (MEM) comprises a read-only memory ROM portion and a rewriteable portion, such as a random access memory RAM and FLASH memory. The information used to communicate with different external parties, e.g. a CD-ROM, other devices and the user, is transmitted through the I/O means (I/O) to/from the central processing unit (CPU). If the data processing device is implemented as a mobile station, it typically includes a transceiver Tx/Rx, which communicates with the wireless network, typically with a base transceiver station (BTS) through an antenna. User Interface (UI) equipment typically includes a display, a keypad, a microphone and a loudspeaker. The data processing device may further comprise connecting means MMC, such as a standard form slot, for various hardware modules, which may provide various applications to be run in the data processing device.

An embodiment of the enhanced multilingual automatic speech recognition system, applicable for instance in a data processing device described above, is illustrated in FIG. 3. The general functional blocks of the ML-ASR engine include the vocabulary file, the automatic language identification (LID) and the multilingual acoustic modeling modules (AMM), like the prior known ML-ASR engine. However, contrary to the prior known ML-ASR engine, the on-line pronunciation modeling is implemented as a TTP module operating with one or more separate TTP model packages (TTP_mp1, TTP_mp2, . . . , TTP_mpN). Each TTP model package provides the phoneme set and the data of the pronunciation model typically for one language. In certain occasions, it may be viable to include two or more structurally similar languages in the same TTP model package. The TTP model packages can be implemented as modules, which are separate from the rest of ML-ASR engine code. The TTP module activates only one TTP model package at a time. Because the TTP modeling scheme does not need to provide phonemes to all the supported languages, the limitations set by the memory restrictions of the acoustic modeling module AMM are no longer very critical. Accordingly, the number of language-dependent phonemes can be increased significantly in each TTP model package, thus resulting in increased accuracy of speech recognition. Since the on-line pronunciation is implemented with separate TTP model packages, the implementation of the ML-ASR engine does not set any limitations to the number of the target languages. On the other hand, the separate TTP model packages allow the number of target languages to be limited to only a few, even to one, instead of all the supported languages, if desired.

Since the TTP model packages are separate from the rest of ML-ASR engine code, the operation of the other parts of the ML-ASR engine is independent of the TTP models. This allows run-time configuration of the phoneme definitions and the TTP model in each TTP model package. The TTP models can be configured and modified whenever there is a change in the phoneme definitions or whenever new training material is available for constructing the TTP models.

The number of the target languages (i.e. the number of the TTP model packages) is not limited by the structure or the operation of the rest of the ML-ASR engine. Only the available memory size may restrict the number of the target languages. The independence of TTP model packages from the rest of ML-ASR engine also allows run-time configuration of the TTP model package assembly and switch between the languages.

The ML-ASR engine can be executed on various platforms. Therefore, the TTP model packages are preferably stored in a binary format, which makes them executable, as such, in the ML-ASR engine and also portable across various platforms running the ML-ASR engine.

Initially, the TTP models are given in textual form defining the phoneme set of each language and the data of the pronunciation models. The pronunciation dictionary is stored in the memory of the device. The dictionary can also be downloaded from an external memory device, e.g. from a CD-ROM or a network. The pronunciation dictionary comprises entries that, in turn, each include a word in a sequence of character units (text sequence) and in a sequence of phoneme units (phoneme sequence). The sequence of phoneme units represents the pronunciation of the sequence of character units. So-called pseudophoneme units can also be used when a letter maps to more than one phoneme.

The representation of the phoneme units is dependent on the phoneme notation system used. Several different phoneme notation systems can be used, e.g. SAMPA and IPA. SAMPA (Speech Assessment Methods Phonetic Alphabet) is a machine-readable phonetic alphabet. The International Phonetic Association provides a notational standard, the International Phonetic Alphabet (IPA), for the phonetic representation of numerous languages. A dictionary entry for the word “father” using the SAMPA phoneme notation system could be for example:

| Text Sequence | Phoneme Sequence |
|---|---|
| Father | F A: D @ |

However, the phoneme notation system used is not relevant for the implementation of the enhanced multilingual automatic speech recognition system, but any known phoneme notation system can be used in the pronunciation dictionaries.

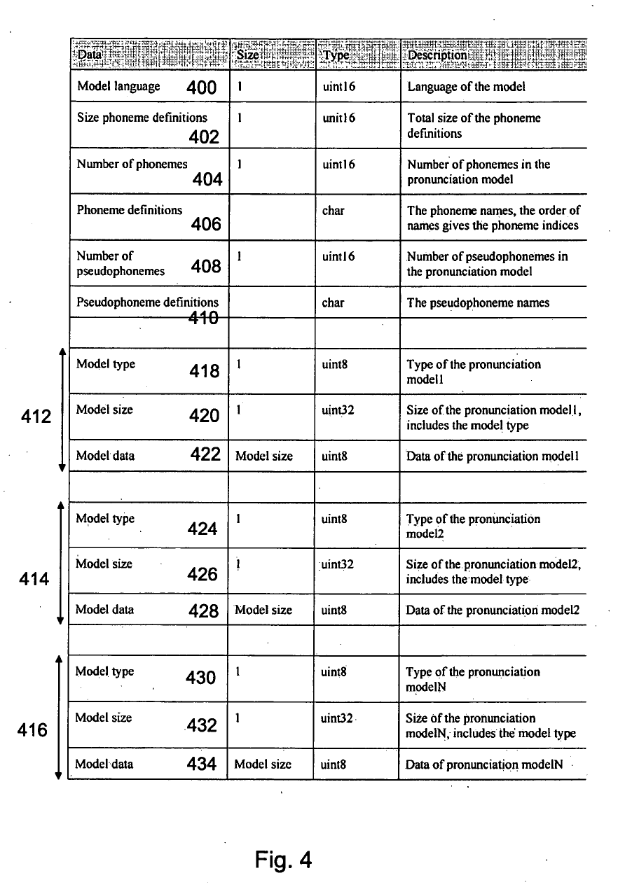

The structure of the TTP model package is further illustrated by referring to the table of FIG. 4. Each TTP model package includes the definition of the model language (400), the total size of the phoneme definitions (402), the number of phonemes and pseudophonemes (404, 408) in a pronunciation model, phoneme and pseudophoneme names (406, 410) and one or more pronunciation models (412, 414, 416). There are at least four kinds of pronunciation models (TTP modeling methods) available: uncompressed/compressed look-up tables, pronunciation rules, decision trees, and neural networks. Because there might be more than one pronunciation model in use for a given language, the term “TTP model package” is used, since it contains the phoneme definitions and all the TTP methods that are in use for the language. For example one could use the uncompressed look-up table and the pronunciation rules, or uncompressed look-up table and the decision trees, or uncompressed look-up table and neural networks to model the pronunciation of a language. In order to have accurate pronunciation models, the ML-ASR engine code does not preferably set any restrictions on the definition of the phoneme set.

For each pronunciation model, there are definitions for the model type (i.e. TTP modeling method) (418, 424, 430), the size of the model (420, 426, 432) and the actual pronunciation model data (422, 428, 434). The number of pronunciation models is theoretically not limited by any means, which is illustrated in the exemplary illustration in the table of FIG. 4 by denoting the last pronunciation model (416) with an integer N.

In order to have fast initialization at the start-up of the ML-ASR engine, the TTP models can be converted into the binary form that contains the data of the models. All the TTP models of the language are stored in one or more binary files. The phoneme definitions should be stored in the binary file also since there should be no restrictions on the phoneme definitions of the language. Therefore the table of FIG. 4 represents the structure of such a binary TTP model package.

The TTP model package is configurable since the user can edit the phoneme definitions of the TTP models that are presented in the textual form. These phoneme definitions are directly stored in the TTP model package. For the compatibility reasons, all the data of the table of FIG. 4 are kept byte aligned, i.e. the 16-bit variables are stored starting at even bytes, and the 32-bit variables are stored starting at the bytes dividable by four. With this implementation it is ensured that the TTP model packages can be transferred to various platforms running the ML-ASR engine, since the data is modified into platform-independent format.

An example of the user configuring the phoneme definitions of the TTP model is depicted in the flow chart of FIG. 5. The user inserts (500) a new word as a text string input that needs to be converted into a pronunciation model. The input text string may be for instance a name the user has added using I/O means (IO) to a contact database of the electronic device (ED). First the language identification unit (LID) seeks to identify (502) the language of the new word by scanning through the vocabulary file. In response to the language identification, the TTP model package including the phoneme definitions of the identified language is activated (504).

A matching entry needs to be searched (506) from the one or more pronunciation models of the TTP model package. Finding the matching entry is based on comparing the input text string to the character units of the entries in the TTP model package. There are several methods and algorithms for finding the match entry, the use of which is typically dependent on the pronunciation model. These algorithms are known to a skilled person as such, and their implementation is does not belong to the scope of the invention. When the matching entry is found, the phoneme units of the entry are selected and concatenated to create (508) the sequence of phonemic units, which is stored in the TTP model package.

After the sequence of phoneme units is created, it is further processed in the acoustic modelling module (AMM), whereby an acoustic model for the sequence is created (510). According to one embodiment, the acoustic pronunciation model is created for each phoneme using the hidden Markov models (HMM). The acoustic models are then concatenated (512) and a recognition model for the new vocabulary item is created.

The ML-ASR engine can preferably be configured for a set of languages from a specific geographical area. The ML-ASR engine can be provided with a default language package, which is a collection of TTP model packages that cover the languages of a specific geographical area. The TTP model packages can be easily grouped together to form various language packages.

The language package is configured in a text file called the language configuration file for the ML-ASR engine. The language configuration file specifies the languages and the associated TTP model packages. If the language configuration is specified in a text file, the engine is initialized first by loading the data, which determines the language configuration. Alternatively, the language configuration can be stored in a memory, such as a flash memory, of an embedded device, such as a mobile terminal, from which memory the configuration data can be directly read.

The TTP module of the ML-ASR engine configures itself for the language dependent phoneme sets and TTP model packages during run-time. Only one TTP model package is activated at a time. The TTP data for the specific language configuration is stored in the memory of the device. The vocabulary for which the pronunciations are generated is scanned language by language. For each language, the phoneme definitions and the instances of the TTP model data structures are initialized from the corresponding TTP model package that belongs to the active language configuration. If a new word belonging to another language, i.e. to another TTP model package, needs to be entered in the corresponding TTP model package, the phoneme definitions and the instances of the TTP model data structures of the active TTP model package are cleared from the memory of the device and the language of the new word is searched for. This can be carried out as run-time switching between language specific phoneme definitions.

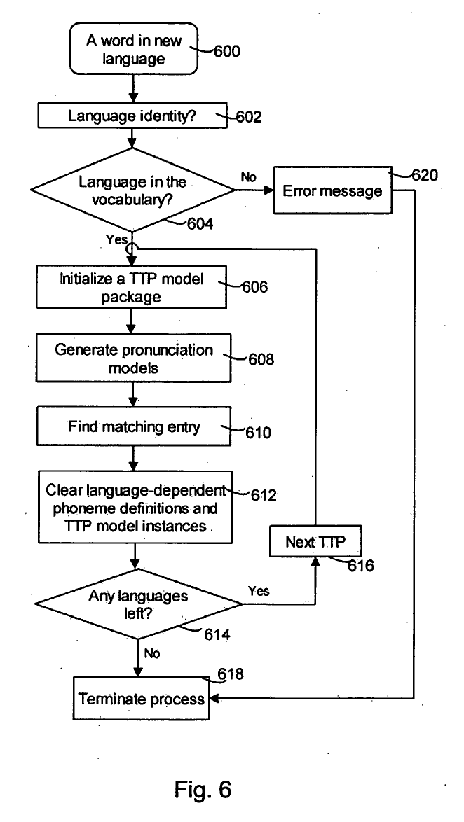

The run-time switching between the TTP model packages is depicted in a flow chart according to FIG. 6. In the electronic device (ED), wherein speech recognition is applied, the central processing unit receives a textual input through the I/O means (IO), when the user of the device enters one or more new words into a recognition vocabulary (600). The language identification unit LID seeks to identify (602) the language of each word and scans through the language configuration file (604).

If the language of the word is found from the language configuration file, the language dependent phoneme definitions and the instances of the TTP models are initialized from the corresponding TTP model package (606). Then the phonetic transcription for the words of the selected language must be generated (608). Finding a matching entry (610) is carried out by processing the TTP model package in relation to the written form of the word. After the phonetic transcriptions have been found, the language dependent phoneme definitions and the instances of the TTP models can be cleared (612).

Thereafter, it is checked whether there are any other TTP model packages available (614). If there is another TTP model package (616), the same procedure (steps 606-612) is carried out for that TTP model package in order to find a matching entry for the word in any other language. When there are no more languages (TTP model packages) to scan, the phonetic transcriptions in all target languages have been found and the process is terminated for that particular word (618).

However, if the word is not found when scanning the language configuration file (604), an error or warning message (620) can be shown to the user indicating that any correct phonetic transcription in the given language may not be available. Then the process can be terminated for that particular word (618).

The source code of the other parts of the ML-ASR engine is not affected by the run-time switching between the language specific phoneme definitions. However, the phoneme definitions in the other parts of the engine need to be updated after the switch.

In addition to the run-time switching of the TTP model packages and phoneme configurations, the run-time switching in the language configuration is enabled. This is achieved by clearing the data of the current language package and initializing for the data of the new language package.

The functionality of the invention may be implemented in a terminal device, such as a mobile station, most preferably as a computer program which, when executed in a central processing unit CPU, affects the terminal device to implement procedures of the invention. Functions of the computer program SW may be distributed to several separate program components communicating with one another. The computer program may be stored in any memory means, e.g. on the hard disk or a CD-ROM disc of a PC, from which it may be downloaded to the memory MEM of a mobile station MS. The computer program may also be downloaded via a network, using e.g. a TCP/IP protocol stack.

Consequently, there is provided a computer program product, loadable into the memory of a data processing device, which is configured to modify speech recognition data in a multilingual speech recognition system. The computer program product comprises program code for entering at least one text item in the device via an input means; program code for identifying the language of the text item entry; program code for activating, from a group of a plurality of separate pronunciation modelling units, the pronunciation modelling unit including a phoneme set and pronunciation model for the language corresponding to the language identified in the language identification unit; program code for obtaining a phoneme transcription best corresponding to said text item entry; and program code for storing a character string of the text item entry with the corresponding the obtained phoneme transcription in said pronunciation modelling unit.

As yet another aspect, the TTP model package can be implemented as a computer program product, loadable into the memory of a data processing device, which is configured to model pronunciation in a speech recognition system, the computer program product comprising program code for modelling a phoneme set and pronunciation model for at least one language.

It is also possible to use hardware solutions or a combination of hardware and software solutions to implement the inventive means. Accordingly, each of the computer program products above can be at least partly implemented as a hardware solution, for example as ASIC or FPGA circuits, in a hardware module comprising connecting means for connecting the module to an electronic device and various means for performing said program code tasks, said means being implemented as hardware and/or software.

It will be obvious to a person skilled in the art that, as the technology advances, the inventive concept can be implemented in various ways. The invention and its embodiments are not limited to the examples described above but may vary within the scope of the claims.

1. A speech recognition system comprising
a language identification unit for identifying the language of a text item entry;
at least one separate pronunciation modelling unit including a phoneme set and pronunciation model for at least one language;
means for activating the pronunciation modelling unit including the phoneme set and pronunciation model for the language corresponding to the language identified in the language identification unit for obtaining a phoneme transcription for the entry; and
a multilingual acoustic modelling unit for creating a recognition model for the entry.

2. A system according to claim 1, wherein
the at least one separate pronunciation modelling unit includes one or more of the following pronunciation models: look-up tables, pronunciation rules, decision trees, or neural networks.

3. A system according to claim 1, wherein
the at least one separate pronunciation modelling unit is stored as a binary file.

4. A system according to claim 1, wherein
the at least one separate pronunciation modelling unit is run-time configurable.

5. A system according to claim 1, wherein
said means for activating the pronunciation modelling unit are arranged to switch run-time between a plurality of separate pronunciation modelling units according to the language identification of the text item entry.

6. A method for modifying speech recognition data in a multilingual speech recognition system, the method comprising
entering at least one text item in the speech recognition system via an input means;
identifying the language of the text item entry;
activating, from a group of a plurality of separate pronunciation modelling units, the pronunciation modelling unit including a phoneme set and pronunciation model for the language corresponding to the language identified in the language identification unit;
obtaining a phoneme transcription corresponding to said text item entry; and
storing a character string of the text item entry with the corresponding obtained phoneme transcription in said pronunciation modelling unit.

7. A method according to claim 6, further comprising
carrying out the method run-time in said multilingual speech recognition system.

8. A method according to claim 6, further comprising switching run-time the activation of the pronunciation modelling unit between a plurality of separate pronunciation modelling units according to the language identification of the text item entry.

9. A computer program product, loadable into the memory of a data processing device, for modifying speech recognition data in a multilingual speech recognition system, the computer program product comprising
program code for entering at least one text item in the device via an input means;
program code for identifying the language of the text item entry;
program code for activating, from a group of a plurality of separate pronunciation modelling units, the pronunciation modelling unit including a phoneme set and pronunciation model for the language corresponding to the language identified in the language identification unit;
program code for obtaining a phoneme transcription corresponding to said text item entry; and
program code for storing a character string of the text item entry with the corresponding the obtained phoneme transcription in said pronunciation modelling unit.

10. A detachable hardware module for modifying speech recognition data in a multilingual speech recognition system, the module comprising
connecting means for connecting the module to an electronic device;
means for entering at least one text item in the device via an input means;
means for identifying the language of the text item entry;
means for activating, from a group of a plurality of separate pronunciation modelling units, the pronunciation modelling unit including a phoneme set and pronunciation model for the language corresponding to the language identified in the language identification unit;
means for obtaining a phoneme transcription corresponding to said text item entry; and
means for storing a character string of the text item entry with the corresponding the obtained phoneme transcription in said pronunciation modelling unit.

11. A detachable hardware module for modelling pronunciation in a speech recognition system, the module comprising
connecting means for connecting the module to an electronic device; and
means for modelling a phoneme set and pronunciation model for at least one language.

12. An electronic device configured to carry out speech recognition, the device comprising
a language identification unit for identifying the language of a speech or text item entry;
at least one separate pronunciation modelling unit including a phoneme set and pronunciation model for at least one language;
means for activating the pronunciation modelling unit including the phoneme set and pronunciation model for the language corresponding to the language identified in the language identification unit for obtaining a phoneme transcription for the entry; and
a multilingual acoustic modelling unit for creating a recognition model for the entry.

13. An electronic device according to claim 12, wherein
the at least one separate pronunciation modelling unit includes one or more of the following pronunciation models: look-up tables, pronunciation rules, decision trees, or neural networks.

14. An electronic device according to claim 12, wherein
the at least one separate pronunciation modelling unit is stored as a binary file.

15. An electronic device according to claim 12, wherein
the at least one separate pronunciation modelling unit is run-time configurable.

16. An electronic device according to claim 12, wherein
said means for activating the pronunciation modelling unit are arranged to switch run-time between a plurality of separate pronunciation modelling units according to the language identification of the text item entry.

17. An electronic device according to claim 12, comprising
connecting means for connecting a detachable hardware module comprising means for means for modelling a phoneme set and pronunciation model for at least one language.
